(19) United States
(12) Patent Application Publication
(10) Pub. No.: US 2017/0290311 A1
(43) Pub. Date: Oct. 12, 2017

(54) Fish And Game Device

(71) Applicant: Robert Harr, Kasilof, AK (US)

(72) Inventor: Robert Harr, Kasilof, AK (US)

(21) Appl. No.: 15/471,776

(22) Filed: Mar. 28, 2017

Related U.S. Application Data
(60) Provisional application No. 62/320,462, filed on Apr. 9, 2016.

(51) Int. Cl. A01K 85/01; A01M 99/00; A01K 83/00; A01M 31/00; A01K 99/00; A01K 91/04

(52) U.S. Cl. CPC A01K 85/01; A01K 99/00; A01K 91/04; A01K 83/00; A01M 31/008; A01M 99/00

(57) ABSTRACT

A fish and game device is disclosed. An example fish and game device includes a central tubing portion, an absorbent material provided around at least a portion of the central tubing portion, and a mesh material provided over the absorbent material. The mesh material retains the absorbent material adjacent the central tubing portion. A scent on the absorbent material may be released through the mesh material into a surrounding environment to attract fish or wildlife.

### PRIORITY CLAIM

This application claims the priority filing date of U.S. Provisional Patent Application No. 62/320,462 filed Apr. 9, 2016 titled “Fish and Game Device” of Robert Harr, hereby incorporated by reference in its entirety as though fully set forth herein.

### BACKGROUND

Fishing can be done for leisure, sport, or commercial purposes. There is a lot of fishing equipment on the market, including rods, reels, and tackle, not to mention equipment such as fishing boats and electronic fish finders.

### BRIEF DESCRIPTION OF THE DRAWINGS

FIG. 1 shows an example fish and game device.

FIGS. 2A-B are additional views of the example fish and game device shown in FIG. 1.

FIGS. 3A-D show example components of the fish and game device.

FIG. 4 shows the example fish and game device as it may be configured to hang in a tree.

FIG. 5 shows the example fish and game device as it may be configured to hang on a fence post.

FIG. 6 shows the example fish and game device as it may be configured on a fishing line.

### DETAILED DESCRIPTION

Fish and game are attracted by movement and/or scent. Scents may be used to attract fish to a lure or bait that has a hook or means to hold a fish or other types of fish or crustaceans (e.g., crab, lobster, shrimp, etc.). Similarly, scents may be used to attract fish and game (including any wildlife and aviary), e.g., to hunters.

Predatory fish, such as halibut, follow a scent trail from the baits attached to a hook. Many scent products are available for bait, such as herring and other bait fish that may be soaked in or injected with additional scents to attract fish or crustaceans to the catching mechanisms.

A fish and game device is disclosed herein which attracts fish to the catching device with a longer lasting mapping position. An example fish and game device includes a core (e.g., central tubing portion), an absorbent material provided around at least a portion of the core, and a mesh material provided over the absorbent material. The mesh material retains the absorbent material adjacent the core. A scent on the absorbent material may be released through the mesh material into a surrounding environment to attract fish or wildlife.

The fish and game device may be implemented as a fishing device, to attract other game (e.g., for viewing, trapping, or hunting), or for any other application in which it is desired to attract fish or game by scent. For example, the fish and game device may be implemented for training animals (e.g., wild animals or domesticated pets such as dogs).

Before continuing, it is noted that as used herein, the terms “includes” and “including” mean, but is not limited to, “includes” or “including” and “includes at least” or “including at least.” The term “based on” means “based on” and “based at least in part on.” The term “fish and game” or “game” is used broadly herein to refer to any wild or domesticated bird, fish, reptile, or animal that can be attracted by scent.

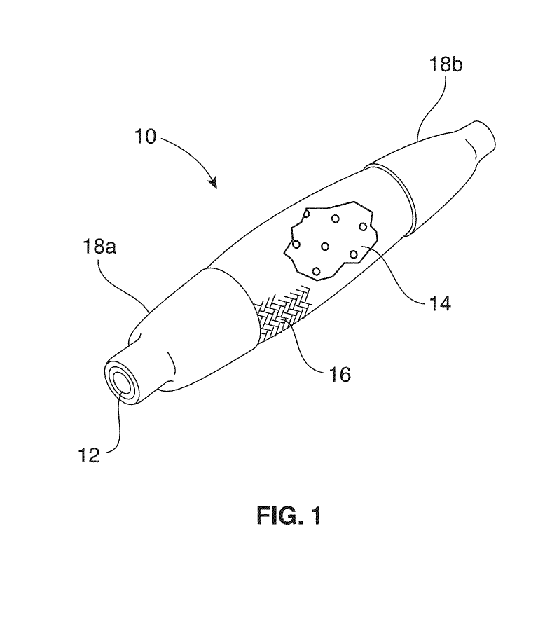

FIG. 1 shows an example fish and game device 10. In an example, the fish and game device 10 includes a core 12. An absorbent material 14 (shown in the broken-away view in FIG. 1) is provided around at least a portion of the core 12. A mesh material 16 is provided over the absorbent material 14 to retain the absorbent material 14 adjacent the core (e.g., to wrap the absorbent material 14). The mesh material 16 may also include openings (e.g., the “mesh”) to enable scent on the absorbent material 14 to be released through the mesh material 16 into a surrounding environment.

In an example, the fish and game device 10 includes end wraps 18a and 18b to retain the mesh material 16. For example, the end wraps 18a and 18b may be heat shrink material that is fitted over the ends and heat-shrunk. Other examples are also contemplated. For example, the end wraps may be ties or other fasteners.

In an example, an absorbent material is rolled around a nylon, polypropylene or polyethylene tube that may vary in size and/or length. The absorbent material is formed as a matted fabric and is rolled to proper length, width and desired thickness around the desired tube size. In an example, the absorbent material may include a super-absorbent compound formed into a simulated fabric-like material. The chemical family name is Olefin and or chemical name Polypropylene or Polyethylene. The known materials are inert and will not harm humans, fish, crustaceans, or wildlife.

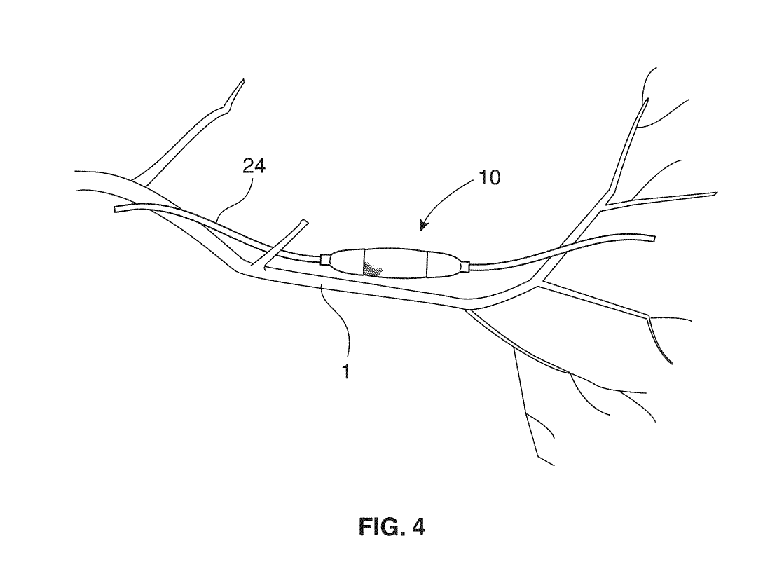

Although not shown in FIG. 1, the fish and game device 10 may include an external attachment (e.g., as illustrated in FIGS. 4-6). The type of external attachment may depend at least to some extent on the intended application. For example, the external attachment may include a hook or snare where the intended application is to catch the fish or game. The external attachment may also include an eyelet for attaching a chain, cord, or the like, e.g., for hanging the fish and game device 10. For example, the external attachment may also include a cord, cable, or chain, e.g., where the intended application is only to lure the fish or game to an area for viewing or other purpose.

In an example, solid steel, stainless steel, wood, carbon fibers, polymers, poly, nylon or other materials may also be used. Hooks, eyelets, swivels, chains or cabling may be attached to the device. The attachments may be formed, welded, brazed, soldered, screwed and affixed in some fashion to the device as part of assembly. If the assembly has a tube design the user of the device may choose to place a line, cable or string through the inside of the tube that will be used to attach the device to the catching mechanism. Tubes or solid rods may be of various sizes in lengths or thickness. The loom, mesh, or sock materials may be in various sizes, lengths, colors, thickness, strengths, hole sized or other mesh pattern designs.

The fish and game device 10 may also include a non-sharpened end and/or a sharpened end. For example, one (or both) ends of the core 12 may be sharpened and extend out from the ends 18a-b so that the core 12 serves as a stake and can be driven into the ground, tree trunk, or other surface.

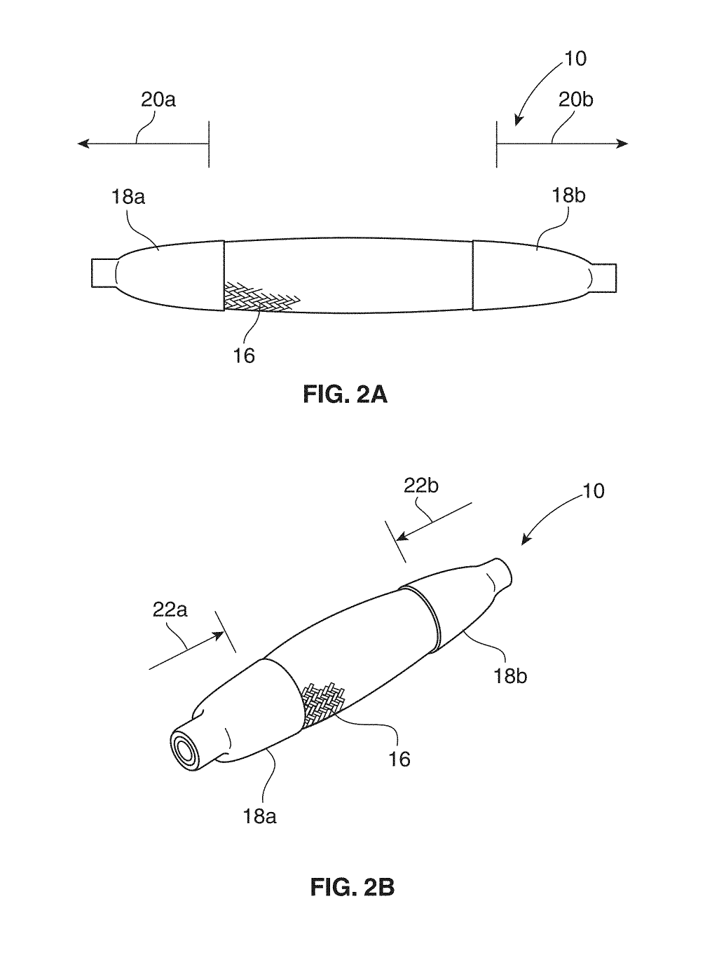

FIGS. 2A-B are additional views of the example fish and game device 10 shown in FIG. 1. In FIG. 2A, the fish and game device 10 is shown in an extended form, wherein the openings of the mesh material 16 are partially or fully closed. This may be accomplished, e.g., by pulling the ends 18a and 18b away from one another as illustrated by arrows 20a-b. For example, during non-use (e.g., shipping, transport, or storage) the fish and game device 10 may be configured in such a manner so as to minimize loss of scent. In FIG. 2B, the fish and game device 10 is shown with the openings of the mesh material 16 partially or fully open. This may be accomplished, e.g., by pushing the ends 18a and 18b toward one another as illustrated by arrows 22a-b. For example, during use to attract fish or game, the fish and game device 10 may be configured in such a manner so as to release scent.

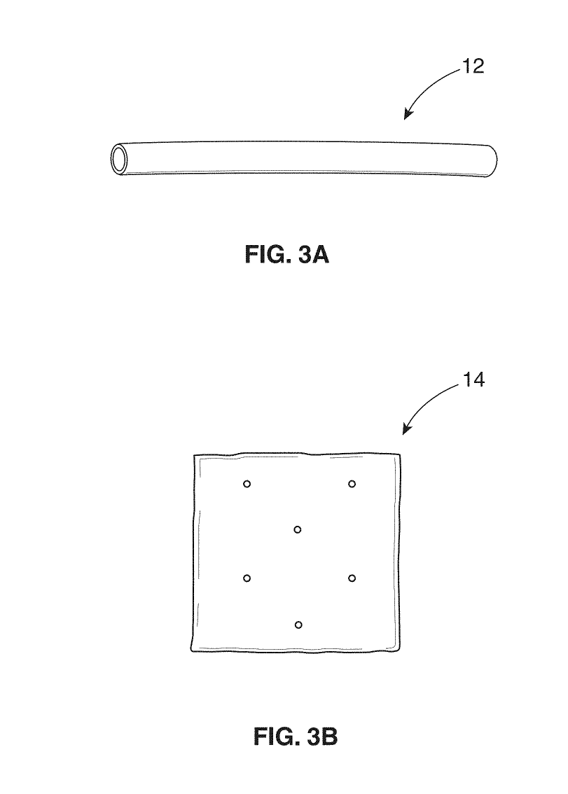

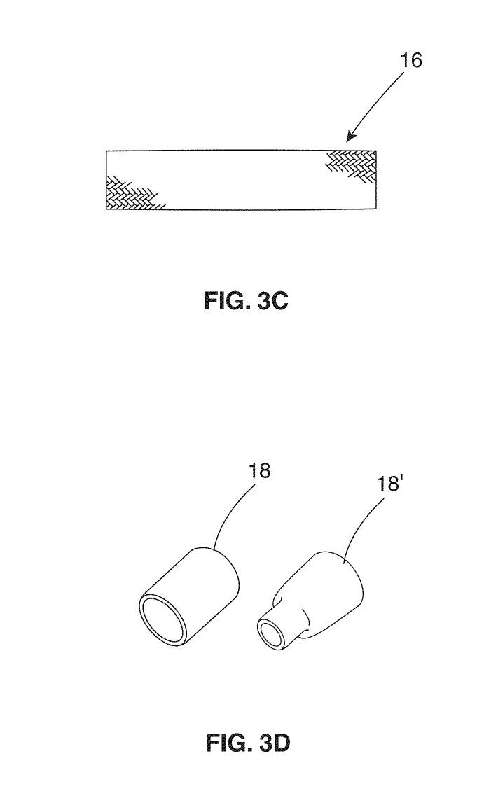

FIG. 3A shows an example core 12 of the fish and game device 10. The core 12 may extend for all or a portion of the length of the device 10. The core 12 may be solid or hollow (e.g., tubing). It is noted that the core 12 within the device 10 may also be made from any suitable materials such as steel, copper, stainless steel, wood or other products providing a void throughout the inside of the device. External cords or devices may be attached or affixed to the core 12, e.g., with a coupling device, welded, brazed, soldered, threaded, screwed and/or otherwise fastened to the core 12.

According to a configuration where the core 12 is a tubing, the tubing may be implemented as the internal connection of the assembly, such as to a line, cable, hook, eyelet or another tube that a line or cable may be inserted through the assembly. In another example, a solid stock assembly can be inserted through the tubing that is the core 12 (or the core 12 itself may be solid).

Attaching devices may be connected to the core 12, such as a hook or eyelet, affixed by being screwed, inserted, molded, brazed, soldered, or welded. Other attachments may include, but are not limited to lighted or glow ability within itself, either by battery or by a glow solar lighted or chemical reaction.

FIG. 3B shows an example absorbent material 14 of the fish and game device 10. The absorbent material 14 may include a fiber or matting material that absorbs scent, without masking the scent, so that the scent is readily released. In an example, the absorbent material is a super-absorbent. Example super-absorbents include Olefin, Polypropylene or Polyethylene. The absorbent may be a scent (or scents) selected to attract at least one of fish, game, aviary, and wildlife.

The absorbent material 14 may be an Olefin material (polypropylene or polyethylene) that has been manufactured into a super-absorbent material. The absorbent material 14 can be a pad, sheeting or fibrous fluff. The absorbent materials are wrapped around or stuffed around the core 12.

It is noted that many scents are of an oil base mix so the absorbent materials fully draw to a saturation point for performance use. The absorbents described herein only absorb oil based scents and will not absorb water. As such, the device enables longer lasting ability of the scent to remain within the absorbent. This reduces the cause of the washing away but releasing the scent as a roadmap to the area that the scented source is coming from.

FIG. 3C shows an example mesh material 16 of the fish and game device 10. The mesh material 16 may be any suitable material. In an example, the mesh material 16 is an expandable mesh. However, other materials may also be provided, such as but not limited to a loom or other wrap material.

In an example, the mesh netting tube, sock or expand loom is made from nylon, polypropylene, or polyethylene, and is pulled over the absorbent materials and tube assembly to properly fit the length and width of the device.

The mesh loom assembly is placed around the core 12 and the absorbent material 14. The mesh material 14 may be loom sock or other wrap materials such as but not limited to, cotton fibers, carbon fibers, polymers, steels, alloys, and plastics. The mesh material 14 secures the absorbent material 16 to the core 12.

FIG. 3D shows an example of one of the ends 18a-b of the fish and game device 10. The distal and frontal ends 18a-b of the core 12 and the distal and frontal ends of the mesh material 16 (with the absorbent material 14 already installed) may be sealed on each frontal and distal end for securing the assemblies together and made whole. This secures the mesh material 16 around the absorbent material 16 and to the core 12.

In an example, a rubberized heat shrinking material such as a Polyolefin product may be implemented. A selected section or sections of the ends 18a-b are heat shrink tubing (e.g., polyolefin). The heat shrink tubing is illustrated in FIG. 3D in both an expanded form 18 (prior to heat-shrinking), and in a heat-shrunk form 18′ (e.g., following heat-shrinking). The heat shrink 18 forms a taper (e.g., 18′ in FIG. 3D) to the core 12 and to the mesh material 16, thereby concealing the absorbent material 14 within the containment of the device 10.

In another example, a wire string, hog ring wire, crushable tube material like copper, alloys, brass or other materials may also be used in a means to tighten or secure the ends in a closed or sealed position.

In an example, the ends 18a-b may include a glue or other adhesive (e.g., internally so that the ends 18a-b automatically adhere to the mesh material 16. In another example, glue or adhesive may be added to each frontal and distal end of the mesh material 16 and/or core 12.

During assembly, the core 12 (e.g., a nylon tube) may be the central portion of the device 10. The absorbent material 14 may include a scent and may be wrapped around the core 12. The mesh 16 may be fitted over the and absorbent material 14. For example, heat shrink 18 may be fitted over the ends 18a and 18b of the mesh 16 and heat-shrunk (e.g., as shown by 18′) over the ends 18a and 18b of the core 12, leaving the core 12 open on each end (see FIG. 1). Or for example, the ends may be crimped or tied. Other examples are also contemplated. The ends 18a-b may be positioned in such a way that the mesh material 16, absorbent material 14, and core 12, is conjoined into one continuous section developing the invention.

Before continuing, it should be noted that the examples described above are provided for purposes of illustration, and are not intended to be limiting. Other devices and/or device configurations may be utilized to carry out the operations described herein.

FIG. 4 shows the example fish and game device 10 as it may be configured to hang in a tree (e.g., on branch 1). In an example, the fish and game device 10 is configured with a cord 24 extending through the core 12. The cord 24 can be strewn (or otherwise hung) on the branch 1 of the tree.

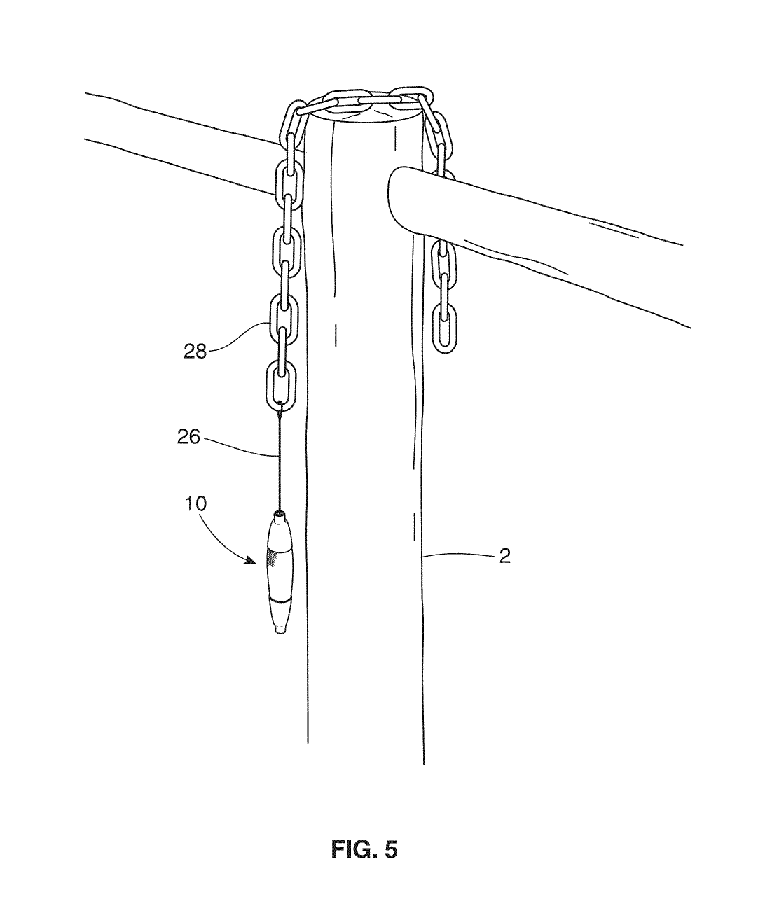

FIG. 5 shows the example fish and game device 10 as it may be configured to hang on a fence post 2. In an example, the fish and game device 10 is configured with a line 26 extending from the core 12 and connected (e.g., tied) to a chain 28. The chain 28 can be hung or connected to the fence post 2.

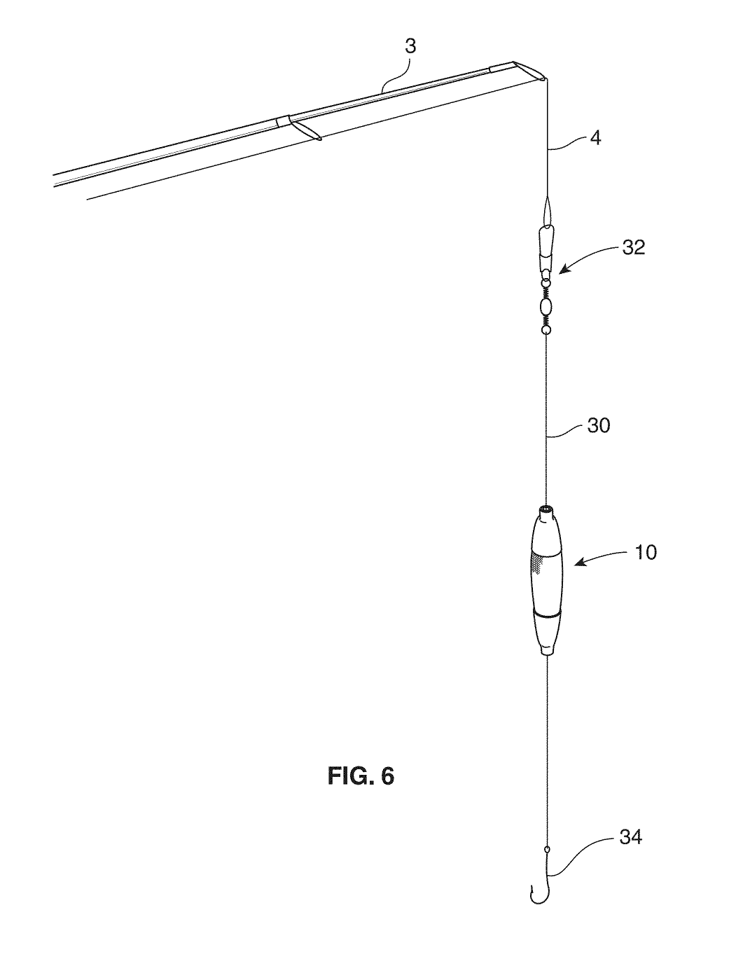

FIG. 6 shows the example fish and game device 10 as it may be configured on a fishing line 4 of a fishing pole 3. In an example, the fish and game device 10 is configured with a line 30 extending through the core 12 and connected (e.g., via spinner 32) to the fishing line 4. The other end of the line 30 may include a fishing hook 34.

It is noted that the device 10 may be implemented for any of a wide variety of applications. The device 10 may thus be configured in any of a number of different ways appropriate for the intended end-use. For example, the device 10 may be configured with a line, string, chain, rope or any other device to hold the device to the desired length, height, elevation either internally or externally in position. Steel spikes may be used to act as a prey type animal. The sharpened spikes can be driven into trees, the ground, bridges, buildings, or other structures. Stakes may also be implemented. As such, the fish and game device 10 can be placed and/or affixed to whatever or wherever the user desires. For example, stakes can be driven into the ground (e.g., in a stream bed to attract fish). Still other implementations and variations of configuration are contemplated, as will be readily understood by those having ordinary skill in the art after becoming familiar with the teachings herein,

It is noted that the examples shown and described are provided for purposes of illustration and are not intended to be limiting. Still other examples are also contemplated.

1. A fish and game device comprising:
a central tubing portion;
an absorbent material provided around at least a portion of the central tubing portion; and
a mesh material provided over the absorbent material to retain the absorbent material adjacent the central tubing portion while enabling a scent on the absorbent material to be released through the mesh material into a surrounding environment.

2. The device of claim 1, further comprising end wraps to retain the mesh material in place. The device of claim 2, wherein the end wraps are heat shrink material.

4. The device of claim 2, wherein the end wraps are ties or other fasteners.

5. The device of claim 1, wherein the absorbent material comprises a super-absorbent device made from an Olefin, Polypropylene or Polyethylene product.

6. The device of claim 1, wherein the absorbent material comprises a fiber or matting material as an absorbent for the scent.

7. The device of claim 1, wherein the central tubing portion comprises a tube or solid stock made of woods, polymers, plastics, steels, alloys, copper, nylons, aluminum, or carbon fibers.

8. The device of claim 1, wherein the central tubing portion comprises an external attachment.

9. The device of claim 8, wherein the external attachment is at least one of a hook, eyelet, and cable.

10. The device of claim 1, wherein the mesh material is an expandable mesh, loom, or wrap material.

11. The device of claim 1, further comprising a distal end and a front end, the distal and front ends configured to secure the absorbent material therebetween.

12. The device of claim 1, wherein the absorbent further comprises at least one scent selected to attract at least one of fish, game, aviary, and wildlife.

13. The device of claim 1, further comprising at least one non-sharpened end.

14. The device of claim 1, further comprising at least one sharpened end.

15. A fish and game device comprising:
a core;
an absorbent material provided around at least a portion of the core;
a scent for the absorbent material; and
a mesh material provided over the absorbent material to retain the absorbent material adjacent the core while enabling the scent to be released into a surrounding environment.

16. The device of claim 15, further comprising end wraps to retain the mesh material in place.

17. The device of claim 15, wherein the absorbent material comprises a fiber or matting material as an absorbent for the scent.

18. The device of claim 15, wherein the core is tubing or solid steel, wood, plastic, or polymer.

19. A method of attracting fish and game comprising:
providing a core;
providing an absorbent material around at least a portion of the core;
providing a scent on the absorbent material; and
providing a mesh material over the absorbent material so that the scent is released into a surrounding environment to attract fish or game.

20. The method of claim 19, further comprising wrapping opposite ends of the mesh material to retain the mesh material in place on the core.
